(19) United States
(12) Patent Application Publication
(10) Pub. No.: US 2019/0307306 A1
(43) Pub. Date: Oct. 10, 2019

(54) MOPPING CLOTH WITH SUPERSTRONG DUST REMOVAL CAPABILITY

(71) Applicant: Lin'an Thumb Cleaning Products Co.,Ltd, Hangzhou (CN)

(72) Inventor: Xiaohua Yang, Hangzhou (CN)

(21) Appl. No.: 16/112,709

(22) Filed: Aug. 25, 2018

(30) Foreign Application Priority Data
Apr. 9, 2018 (CN) 201810311845.0

(51) Int. Cl. A47L 13/16; A47L 13/20; B32B 5/26; B32B 5/02

(52) U.S. Cl. CPC A47L 13/16; A47L 13/20; B32B 5/26; B32B 5/022; B32B 2250/02; B32B 2262/0253; B32B 2262/0284; B32B 2250/20; B32B 2432/00

(57) ABSTRACT

The present disclosure belongs to cleaning products, and specifically relates to mopping cloth with superstrong dust removal capability. The mopping cloth includes a bottom layer nonwoven fabric and a fiber layer. The fiber layer is fixed to at least one surface of the bottom layer nonwoven fabric by a plurality of hot-melt connection lines and the fiber layer is formed by a plurality of ultrafine polyester filaments arranged parallel to each other, or formed by staple fiber tows. The ultrafine polyester filaments in each closed pattern are partially cut off to have a cut, thereby forming irregular three-dimensional surfaces. The mopping cloth is characterized by high raw material utilization rate, strong dust adsorption capability, simple production equipment and low cost.

### CROSS-REFERENCE TO RELATED APPLICATIONS

This application claims to Chinese application No. 201810311845.0 with a filing date of Apr. 9, 2018. The content of the aforementioned applications, including any intervening amendments thereto, are incorporated herein by reference.

### TECHNICAL FIELD

The present disclosure relates to a cleaning product, and particularly to a mopping cloth.

### BACKGROUND

In recent years, flat mops have been used as a floor cleaning tool in more and more families, and the sales volume of mopping cloths matching therewith has increased accordingly. However, mopping cloths, as a disposable article mostly have poor cleaning capability. The key factor is that the friction coefficient of the mopping cloth relative to the floor is not sufficiently high, which is urgent to be solved by the industry insiders.

### SUMMARY

The object of the present disclosure is to overcome above defect mentioned and provide an improvement in mopping cloths, such that the mopping cloth is featured with high raw material utilization rate, strong dust adsorption capability, simple production equipment and low cost.

The technical solution adopted in the present disclosure is:

Mopping cloth with superstrong dust removal capability, comprising a bottom layer nonwoven fabric and a fiber layer; the fiber layer is fixed to at least one surface of the bottom layer nonwoven fabric by a plurality of hot-melt connection lines; the fiber layer comprises a plurality of fibers; and further, the fibers include ultrafine polyester filaments and fiber tows.

The plurality of hot-melt connection lines constitute a plurality of closed patterns;
further, the plurality of hot-melt connection lines constitute a plurality of closed patterns arranged regularly, and the closed pattern is a rhombus, a triangle, a rectangle or a circle.

The fibers of the fiber layer within the closed patterns are partially provided with a cut to form an irregular three-dimensional surface having high dust adsorption capability, thereby endowing the fiber layer with high dust adsorption capability.

The fiber layer is formed by a plurality of ultrafine polyester filaments arranged parallel to each other, or by a plurality of fiber tows arranged parallel to each other.

The length direction of the fiber is parallel to the length direction or the width direction of the bottom layer nonwoven fabric.

The length direction of the cut is perpendicular to the extension direction of the fiber.

An intermediate layer nonwoven fabric is further provided between the bottom layer nonwoven fabric and the fiber layer.

The fiber tow is a PE/PET or PE/PP composite fiber tow.

Further, the cut is formed by sewing one end of the fiber and not sewing the other end of the fiber.

Further, the cut is formed by cutting off the fiber with a cutter.

The beneficial effects of the present disclosure are:

The nonwoven fabric and the ultrafine polyester filaments are composited by hot melting. The filaments do not need to be woven or knitted, and the staple fiber tows do not need to be made into the nonwoven fabrics by various nonwoven fabric production processes, thereby greatly reducing the manufacturing cost of the product.

The fibers in each closed pattern have partially been cut off and form irregular three-dimensional fluffy surfaces after being blown by an air pump. And when the fibers are brought into contact with the floor, dust can be effectively removed in spite of the angle and the floor surface (which may be concave, convex, or have gaps), greatly increasing the use area of the product.

For the existing cloth produced by the weaving process or the nonwoven fabric lapping process, 90% of the surface area of the fibers is within the product, only the front and back of the product can be brought into contact with an object, so most of the raw materials are wasted on the fiber overlapping layers or inside the product. However, in the present disclosure, after the fibers have been cut off, for one fiber, only one percent thereof is hot melted to form a connection point, and any surface of the rest ninety-nine percent thereof is available for the work, thereby greatly improving the utilization rate of the raw materials.

The minimum grammage of the existing filament terry cloth produced by the weaving process is 100 g/m². However, it can be controlled to 40 g/m² in the present disclosure, thereby significantly reducing the raw material cost.

The production equipment for the present disclosure is conventional equipment that is relatively simple, endowing the present disclosure with obvious advantages and making the present disclosure worthy of popularization.

### BRIEF DESCRIPTION OF THE DRAWINGS

FIG. 1 is a front structural view of the present disclosure.

FIG. 2 is an exploded view of the structure of embodiment 1 of the present disclosure, viewed from the top.

FIG. 3 is an exploded view of the structure of embodiment 2 of the present disclosure, viewed from the top.

### DETAILED DESCRIPTION

Further description is made below in connection with the embodiments shown in the drawings.

The mopping cloth with superstrong dust removal capability shown in the drawings includes a bottom layer nonwoven fabric 1 and a fiber layer 3 (preferably a chemical fiber layer) fixed to at least one surface of the bottom layer nonwoven fabric by a plurality of hot-melt connection lines 2. The fiber layer includes a plurality of fibers 31, and the fibers 31 include ultrafine polyester filaments and fiber tows. The fiber layer is formed by a plurality of ultrafine polyester filaments arranged parallel to each other, or by a plurality of fiber tows arranged parallel to each other. Generally, the length of fiber layer is flush with the bottom layer nonwoven fabric, the width of the fiber layer is one-half to two-thirds of the width of the bottom layer nonwoven fabric, and the thickness of the fiber layer is set according to the needs of the user.

The length direction of the fiber is parallel to the length direction or the width direction of the bottom layer nonwoven fabric.

The hot-melt connection lines are formed by heating and melting the chemical fibers and the nonwoven fabrics using a hot-pressing device or an ultrasonic hot-melt welding device and then cooling, so that the chemical fibers and the nonwoven fabrics are integrally connected.

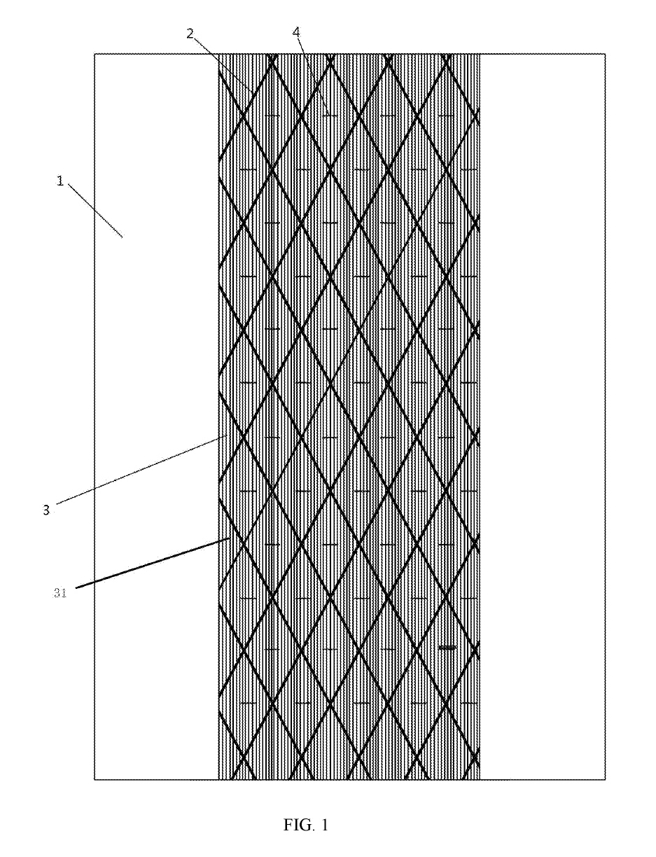

These hot-melt connection lines constitute a plurality of closed patterns arranged regularly, and the closed pattern is a rhombus (as shown in FIG. 1), a triangle, a rectangle or a circle.

After the hot-melt connection lines have been formed, a cut-off operation is performed on some of the fibers within each closed pattern by using a cutter, so that the fibers therein are partially cut off (or the bottom layer nonwoven fabric may be cut together with the fibers). And then the fibers are blown by an air pump to form irregular, fluffy three-dimensional surfaces, so as to effectively improve the dust adsorption capability. As can be seen from the drawings, the length direction of the cut 4 is perpendicular to the extension direction of the fiber, and the length of the cut is determined according to needs (preferably 5-10 mm).

The ultrafine polyester filament is 100% polyester or a blended fiber of polyester and polyamide, the fiber is 600D/1152F, and the monofilament is 0.52D, which is a real ultrafine fiber. The specification of the polyester filament is 300D, 600D, 144F, 288F, 576F, etc.

The fiber tow is a PE/PET or PE/PP composite fiber tow, wherein PE/PET is a composite fiber with the central inner core being PET and the outer ring in the surface layer being PE. And the PE/PP is a composite fiber with the central inner core being PP and the outer ring in the surface layer being PE.

The above-mentioned ultrafine polyester filaments and fiber tows are commercially available.

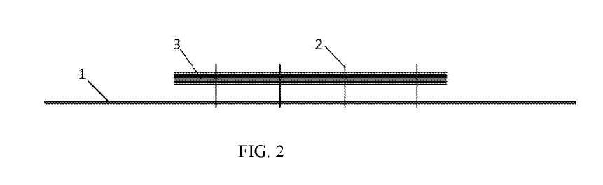

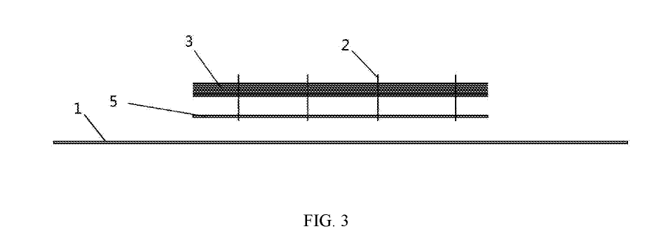

In addition, as can be seen from FIG. 2 and FIG. 3, embodiment 1 is formed by consolidation of the bottom layer nonwoven fabric and the fiber layer through the hot-melt connection lines, while embodiment 2 is formed by consolidation of the bottom layer nonwoven fabric, the fiber layer and an intermediate layer nonwoven fabric 5 between the bottom layer nonwoven fabric and the fiber layer through the hot-melt connection lines. The intermediate layer nonwoven fabric may be flush with the bottom layer nonwoven fabric and the fiber layer in length (i.e. the dimension in the left-right direction in FIG. 1), and may be flush with the fiber layer in width (i.e. the dimension in the up-down direction in FIG. 1).

Finally, it should be noted that the above is merely specific embodiments of the present disclosure. Obviously, the present disclosure is not limited to the embodiments described above, but may have many variants. All the variants that those ordinary skilled in the art could directly derive or conceive on the basis of the present disclosure shall be considered to be within the protection scope of the present disclosure.

What is claimed is:

1. A mopping cloth with superstrong dust removal capability, comprising a bottom layer nonwoven fabric (1) and a fiber layer (3), wherein the fiber layer (3) is fixed to at least one surface of the bottom layer nonwoven fabric (1) by a plurality of hot-melt connection lines (2); and the fiber layer (3) comprises a plurality of fibers (31);
the plurality of hot-melt connection lines constitute a plurality of closed patterns; and
the fibers of the fiber layer (3) within the closed patterns are partially provided with a cut (4) to form an irregular three-dimensional surface having superstrong dust adsorption capability.

2. The mopping cloth with superstrong dust removal capability according to claim 1, wherein the fibers (31) comprise ultrafine polyester filaments and fiber tows.

3. The mopping cloth with superstrong dust removal capability according to claim 2, wherein the fiber layer (3) is formed by the ultrafine polyester filaments arranged parallel to each other.

4. The mopping cloth with superstrong dust removal capability according to claim 2, wherein the fiber layer (3) is formed by the fiber tows arranged parallel to each other.

5. The mopping cloth with superstrong dust removal capability according to claim 1, wherein a length direction of the fiber is parallel to a length direction or a width direction of the bottom layer nonwoven fabric (1).

6. The mopping cloth with superstrong dust removal capability according to claim 1, wherein a length direction of the cut (4) is perpendicular to an extension direction of the fiber.

7. The mopping cloth with superstrong dust removal capability according to claim 1, wherein an intermediate layer nonwoven fabric (5) is further provided between the bottom layer nonwoven fabric (1) and the fiber layer (3).

8. The mopping cloth with superstrong dust removal capability according to claim 3, wherein the fiber tow is a PE/PET or PE/PP composite fiber tow.

9. The mopping cloth with superstrong dust removal capability according to claim 1, wherein the plurality of hot-melt connection lines constitute a plurality of closed patterns arranged regularly, and the closed pattern is a rhombus, a triangle, a rectangle or a circle.

10. The mopping cloth with superstrong dust removal capability according to claim 1, wherein the cut (4) is formed by sewing one end of the fiber and not sewing the other end of the fiber.

11. The mopping cloth with superstrong dust removal capability according to claim 1, wherein the cut (4) is formed by cutting off the fiber with a cutter.
